(19) United States
(12) Patent Application Publication
(10) Pub. No.: US 2015/0292137 A1
(43) Pub. Date: Oct. 15, 2015

(54) METHODS FOR DETERMINING LOAD MASS AND OPERATING WASHING MACHINE APPLIANCES

(71) Applicant: General Electric Company, Schenectady, NY (US)

(72) Inventors: Ryan Ellis Leonard, Louisville, KY (US); Stephen Edward Hettinger, Louisville, KY (US)

(73) Assignee: General Electric Company, Schenectady, NY (US)

(21) Appl. No.: 14/252,879

(22) Filed: Apr. 15, 2014

(51) Int. Cl. D06F 39/00; G01N 5/00; G01G 19/14

(52) U.S. Cl. CPC D06F 39/003; G01G 19/14; G01N 5/00

(57) ABSTRACT

Methods for determining load mass and operating washing machine appliances are provided. A method for determining load mass includes initially activating a motor to spin a basket of the washing machine appliance, measuring at least one of current or voltage of the motor before or during the initially activating step, and calculating a motor ramp up time based on the at least one of current or voltage. The method further includes deactivating the motor after the motor ramp up time has expired, measuring a first motor coast down time, and calculating a motor velocity based on the first motor coast down time. The method further includes finally activating the motor to spin the basket, deactivating the motor after the motor velocity has been reached, measuring a second motor coast down time, and calculating a load mass in the basket based on the second motor coast down time.

### FIELD OF THE INVENTION

The present disclosure relates generally to washing machine appliances, and more particularly to methods for determining load masses in washing machine appliances and methods for operating washing machine appliances.

### BACKGROUND OF THE INVENTION

Washing machine appliances generally include a tub for containing wash fluid, e.g., water and detergent, bleach and/or other wash additives. A basket is rotatably mounted within the tub and defines a wash chamber for receipt of articles for washing. During operation of such washing machine appliances, wash fluid is directed into the tub and onto articles within the wash chamber of the basket. The basket or an agitation element can rotate at various speeds to agitate articles within the wash chamber in the wash fluid, to wring wash fluid from articles within the wash chamber, etc.

One issue with washing machine appliance performance has been the varying masses and types of loads of articles being washed in the appliance. Operation of the appliance at, for example, a specified speed for a specified time period may not provide optimal performance for every mass and every type of load. Accordingly, it is generally useful to determine the load mass and the load type, and tailor appliance performance to these variables.

Another issue with washing machine appliances has been the amount of water utilized with a load being washed. Excess water or too little water can impact the performance of the appliance and the energy utilized by the appliance. In particular, too little water can allow the articles of the load to bog down the motor, thus negatively impacting the performance of the motor and causing motor wear and potential damage.

Attempts have been made to determine load mass in washing machine appliances, and to monitor water levels during operation. However, known methods and apparatus typically involve complex software, thus increasing the cost of the appliance or preventing commercial use from being viable, or are relatively inaccurate.

Accordingly, improved methods for determining load mass and operating washing machine appliances are desired in the art. In particular, methods which have reduced complexity and are generally viable, cost-effective and accurate would be advantageous.

### BRIEF DESCRIPTION OF THE INVENTION

In accordance with one embodiment of the present disclosure, a method for determining a load mass in a washing machine appliance is provided. The method includes initially activating a motor to spin a basket of the washing machine appliance, measuring at least one of current or voltage of the motor before or during the initially activating step, and calculating a motor ramp up time based on the at least one of current or voltage. The method further includes deactivating the motor after the motor ramp up time has expired, measuring a first motor coast down time, and calculating a motor velocity based on the first motor coast down time. The method further includes finally activating the motor to spin the basket, deactivating the motor after the motor velocity has been reached, measuring a second motor coast down time, and calculating a load mass in the basket based on the second motor coast down time.

In accordance with another embodiment of the present disclosure, a method for operating a washing machine appliance is provided. The method includes determining a load mass in a basket of the washing machine appliance, and flowing a first volume of water into a tub of the washing machine appliance, the basket disposed in the tub. The method further includes determining a load type based on the load mass and the first volume of water. The method further includes agitating the load, and monitoring a travel condition of a motor during the agitating step. The method further includes comparing the travel condition to a predetermined threshold window, and flowing a predetermined secondary volume of water into the tub if the travel condition is outside of the predetermined threshold window.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a washing machine appliance according to an exemplary embodiment of the present subject matter.

FIG. 2 provides a front, section view of a washing machine appliance in accordance with one embodiment of the present disclosure; and

FIG. 3 provides a flow chart of an exemplary method for determining a load mass in a washing machine appliance according to an exemplary embodiment of the present subject matter.

FIG. 4 provides a flow chart of an exemplary method for operating a washing machine appliance according to an exemplary embodiment of the present subject matter.

FIG. 5 provides a look-up table which cross-references load mass and volume to determined load type according to an exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

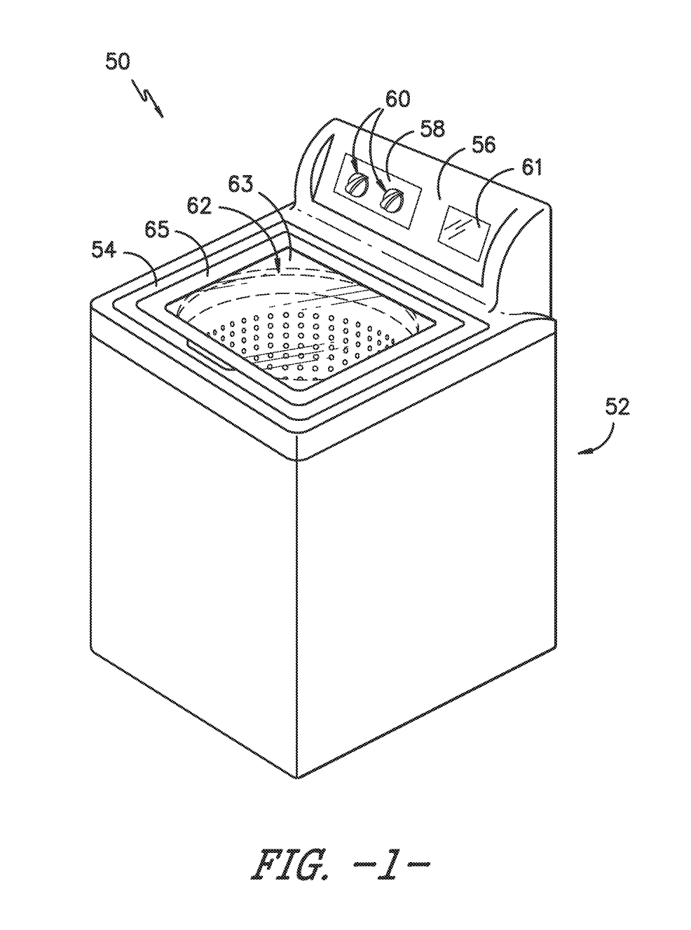

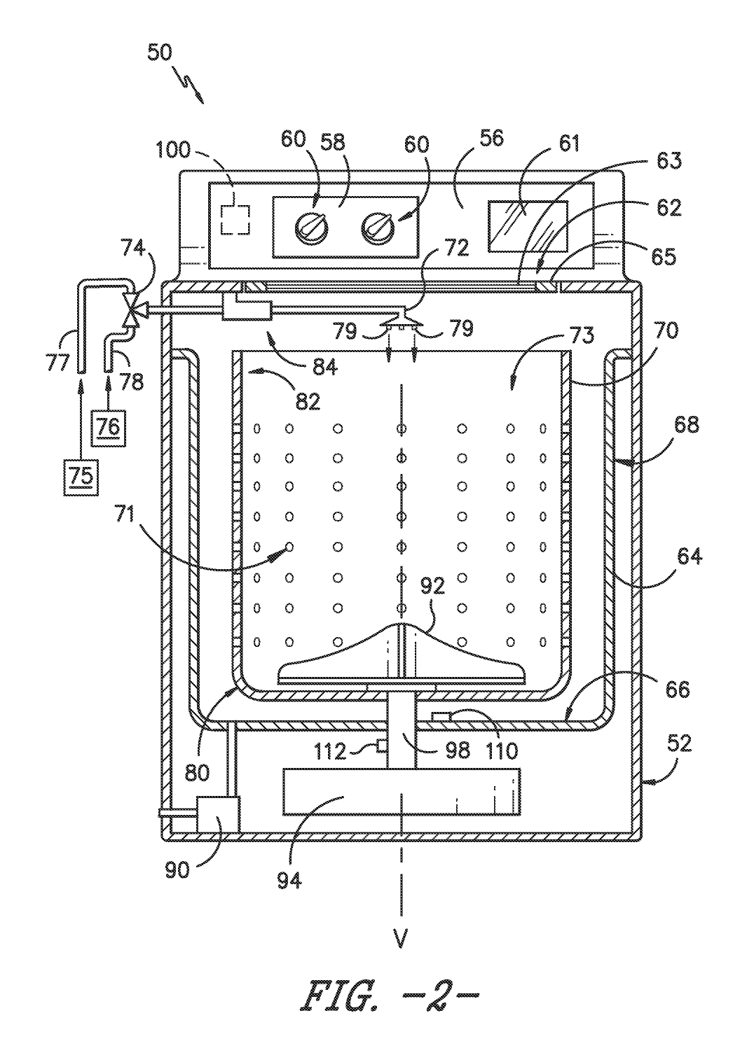

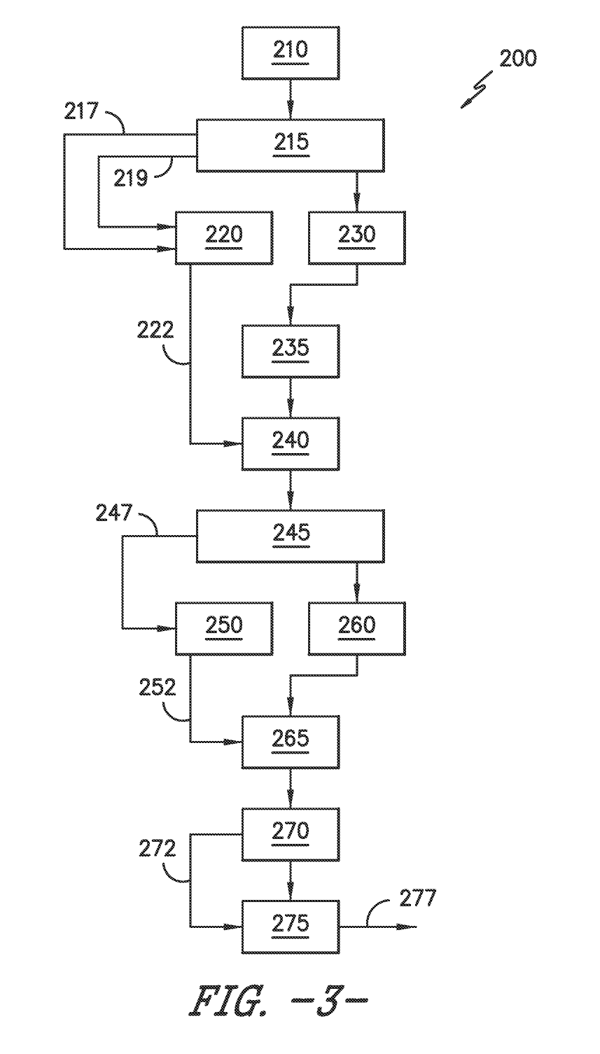

FIG. 1 is a perspective view of a washing machine appliance 50 according to an exemplary embodiment of the present subject matter. As may be seen in FIG. 1, washing machine appliance 50 includes a cabinet 52 and a cover 54. A backsplash 56 extends from cover 54, and a control panel 58 including a plurality of input selectors 60 is coupled to backsplash 56. Control panel 58 and input selectors 60 collectively form a user interface input for operator selection of machine cycles and features, and in one embodiment, a display 61 indicates selected features, a countdown timer, and/or other items of interest to machine users. A lid 62 is mounted to cover 54 and is rotatable between an open position (not shown) facilitating access to a wash tub 64 (FIGS. 2 and 3) located within cabinet 52 and a closed position (shown in FIG. 1) forming an enclosure over tub 64.

Lid 62 in exemplary embodiment includes a transparent panel 63, which may be formed of for example glass, plastic, or any other suitable material. The transparency of the panel 63 allows users to see through the panel 63, and into the tub 64 when the lid 62 is in the closed position. In some embodiments, the panel 63 may itself generally form the lid 62. In other embodiments, the lid 62 may include the panel 63 and a frame 65 surrounding and encasing the panel 63. Alternatively, panel 63 need not be transparent.

FIG. 2 provides a front, cross-section views of washing machine appliance 50. As may be seen in FIG. 2, tub 64 includes a bottom wall 66 and a sidewall 68. A wash drum or wash basket 70 is rotatably mounted within tub 64. In particular, basket 70 is rotatable about a vertical axis V. Thus, washing machine appliance is generally referred to as a vertical axis washing machine appliance. Basket 70 defines a wash chamber 73 for receipt of articles for washing and extends, e.g., vertically, between a bottom portion 80 and a top portion 82. Basket 70 includes a plurality of openings or perforations 71 therein to facilitate fluid communication between an interior of basket 70 and tub 64.

A nozzle 72 is configured for flowing a liquid into tub 64. In particular, nozzle 72 may be positioned at or adjacent top portion 82 of basket 70. Nozzle 72 may be in fluid communication with one or more water sources 75, 76 in order to direct liquid (e.g. water) into tub 64 and/or onto articles within chamber 73 of basket 70. Nozzle 72 may further include apertures 79 through which water may be sprayed into the tub 64. Apertures 79 may, for example, be tubes extending from the nozzles 72 as illustrated, or simply holes defined in the nozzles 72 or any other suitable openings through which water may be sprayed. Nozzle 72 may additionally include other openings, holes, etc. (not shown) through which water may be flowed, i.e. sprayed or poured, into the tub 64.

A main valve 74 regulates the flow of fluid through nozzle 72. For example, valve 74 can selectively adjust to a closed position in order to terminate or obstruct the flow of fluid through nozzle 72. The main valve 74 may be in fluid communication with one or more external water sources, such as a cold water source 75 and a hot water source 76. The cold water source 75 may, for example, be a commercial water supply, while the hot water source 76 may be, for example, a water heater. Such external water sources 75, 76 may supply water to the appliance 50 through the main valve 74. A cold water conduit 77 and a hot water conduit 78 may supply cold and hot water, respectively, from the sources 75, 76 through valve 74. Valve 74 may further be operable to regulate the flow of hot and cold liquid, and thus the temperature of the resulting liquid flowed into tub 64, such as through the nozzle 72.

An additive dispenser 84 may additionally be provided for directing a wash additive, such as detergent, bleach, liquid fabric softener, etc., into the tub 64. For example, dispenser 84 may be in fluid communication with nozzle 72 such that water flowing through nozzle 72 flows through dispenser 84, mixing with wash additive at a desired time during operation to form a liquid or wash fluid, before being flowed into tub 64. In some embodiments, nozzle 72 is a separate downstream component from dispenser 84. In other embodiments, nozzle 72 and dispenser 84 may be integral, with a portion of dispenser 84 serving as the nozzle 72. A pump assembly 90 (shown schematically in FIG. 2) is located beneath tub 64 and basket 70 for gravity assisted flow to drain tub 64.

An agitation element 92, shown as an impeller in FIG. 2, may be disposed in basket 70 to impart an oscillatory motion to articles and liquid in chamber 73 of basket 70. In various exemplary embodiments, agitation element 92 includes a single action element (i.e., oscillatory only), double action (oscillatory movement at one end, single direction rotation at the other end) or triple action (oscillatory movement plus single direction rotation at one end, singe direction rotation at the other end). As illustrated in FIG. 2, agitation element 92 is oriented to rotate about vertical axis V. Alternatively, basket 70 may provide such agitating movement, and agitation element 92 is not required. Basket 70 and agitation element 92 are driven by a motor 94, such as a pancake motor. As motor output shaft 98 is rotated, basket 70 and agitation element 92 are operated for rotatable movement within tub 64, e.g., about vertical axis V. Washing machine appliance 50 may also include a brake assembly (not shown) selectively applied or released for respectively maintaining basket 70 in a stationary position within tub 64 or for allowing basket 70 to spin within tub 64.

Various sensors may additionally be included in the washing machine appliance 50. For example, a pressure sensor 110 may be positioned in the tub 64 as illustrated. Any suitable pressure sensor 110, such as an electronic sensor, a manometer, or another suitable gauge or sensor, may be utilized. The pressure sensor 110 may generally measure the pressure of water in the tub 64. This pressure can then be utilized to estimate the height or level of water in the tub 64. Additionally, a suitable speed sensor 112 can be connected to the motor 94, such as to the output shaft 98 thereof, to measure speed and indicate operation of the motor 94. Other suitable sensors, such as temperature sensors, etc., may additionally be provided in the washing machine appliance 50.

Operation of washing machine appliance 50 is controlled by a processing device or controller 100, that is operatively coupled to the input selectors 60 located on washing machine backsplash 56 (shown in FIG. 1) for user manipulation to select washing machine cycles and features. Controller 100 may further be operatively coupled to various other components of appliance 50, such as main valve 74, motor 94, pressure sensor 110, speed sensor 112, and other suitable sensors, etc. In response to user manipulation of the input selectors 60, controller 100 may operate the various components of washing machine appliance 50 to execute selected machine cycles and features.

Controller 100 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 100 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 58 and other components of washing machine appliance 50 may be in communication with controller 100 via one or more signal lines or shared communication busses.

In an illustrative embodiment, a load of laundry articles are loaded into chamber 73 of basket 70, and washing operation is initiated through operator manipulation of control input selectors 60. Tub 64 is filled with water and mixed with detergent to form a liquid or wash fluid. Main valve 74 can be opened to initiate a flow of water into tub 64 via nozzle 72, and tub 64 can be filled to the appropriate level for the amount of articles being washed. Once tub 64 is properly filled with wash fluid, the contents of the basket 70 are agitated with agitation element 92 or by movement of the basket 70 for cleaning of articles in basket 70. More specifically, agitation element 92 or basket 70 is moved back and forth in an oscillatory motion.

After the agitation phase of the wash cycle is completed, tub 64 is drained. Laundry articles can then be rinsed by again adding fluid to tub 64, depending on the particulars of the cleaning cycle selected by a user, agitation element 92 or basket 70 may again provide agitation within basket 70. One or more spin cycles may also be used. In particular, a spin cycle may be applied after the wash cycle and/or after the rinse cycle in order to wring wash fluid from the articles being washed. During a spin cycle, basket 70 is rotated at relatively high speeds.

While described in the context of specific embodiments of washing machine appliance 50, using the teachings disclosed herein it will be understood that washing machine appliance 50 is provided by way of example only. Other washing machine appliances having different configurations (such as horizontal-axis washing machine appliances), different appearances, and/or different features may also be utilized with the present subject matter as well.

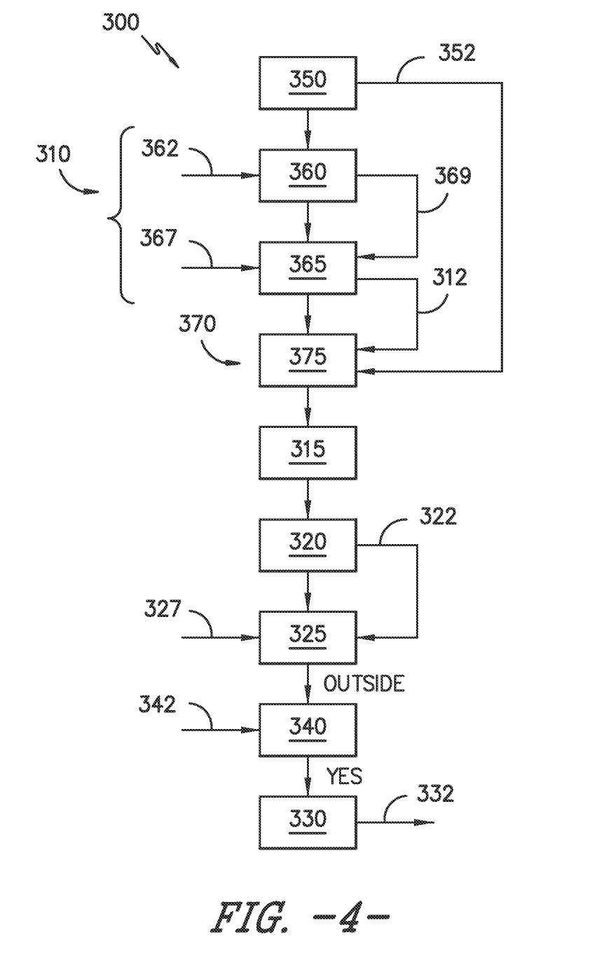

Referring now to FIGS. 3 and 4, various methods may be provided for use with washing machine appliances 50 in accordance with the present disclosure. In general, the various steps of methods as disclosed herein may in exemplary embodiments be performed by the controller 100, which may receive inputs and transmit outputs from various other components of the appliance 50.

For example, as illustrated in FIG. 3 and indicated by reference number 200, methods for determining a load mass in a washing machine appliance 50 are provided. Such methods 200 generally accurately and efficiently determined the mass of a load of articles loaded into a basket 70 for washing. Such mass calculation can advantageously be utilized to tailor various operating conditions of the appliance 50, such as agitation time, agitation profile, spin speed, spin time, etc. for optimal performance. Further, such mass calculations can be utilized for additional determinations by the appliance 50, such as of the load type.

A method 200 may include, for example, the step 210 of initially activating the motor 94 to spin the basket 70 of the washing machine appliance 50. Such step 210 is generally performed after articles forming a load are loaded into the basket 70, and before any substantial amount of water is flowed into the tub 64 to begin washing of the load. (Notably, minimal amounts of water may be initially flowed into the tub 64 before such step 210 for various purposes, such as for use in entrapment protection programs). Accordingly, the load mass determined utilizing method 200 is generally a dry load mass. Method 200 may further include, for example, the step 215 of measuring at least one of current 217 or voltage 219 of the motor 94, such as before (for voltage) or during (for current or voltage) the initially activating step 210. The current 217 and/or voltage 219 may, for example, be measured by the controller 100 in communication with the motor 94, such as through the use of suitable sensors included in or in communication with the motor 94.

Method 200 may further include, for example, the step 220 of calculating a motor ramp up time 222 based the current 217 and/or voltage 219. The ramp up time 222 may generally be a time allotted for the motor 94, when activated, to run before being deactivated for purposes of the present method. Activation may be from a zero velocity state or from suitable predetermined low velocity. The motor ramp up time 222 can be calculated based on the current 217 and/or voltage 219 using, for example, a suitable transfer function or other suitable mathematical relationship. For example, the present inventors have empirically developed relationships between motor ramp up time 222 and current 217 and/or voltage 219, based for example on the relationship between current 217 and motor input torque. In this manner, determination of the load mass as disclosed herein compensates for the input torque.

In some embodiments, a method 200 may further include the step 230 of deactivating the motor 94 after measuring the current 217 and/or voltage 219. In these embodiments, method 200 may then include the step 235 of intermediately activating the motor 94 to spin the basket 70, for a second time. Subsequent steps, as discussed herein, may then follow. In alternative embodiments, such subsequent steps may follow without the need to deactivate and then intermediately activate the motor 94. In these embodiments, adjustments may be made, such as by the controller 100, in real time based on, for example, motor ramp up time 222.

Method 200 may further include, for example, the step 240 of deactivating the motor 94 after the motor ramp up time 222 has expired. Such deactivation can occur, as discussed, after the second activation 235, or after the initial activation 210 once the motor ramp up time 222 has been calculated in real time.

Method 200 may further include, for example, the step 245 of measuring a first motor coast down time 247. The coast down time 247 is generally the time that the motor 94 takes to reach zero velocity or a predetermined low velocity once the motor 94 has been deactivated. Still further, method 200 may include, for example, the step 250 of calculating a motor velocity 252 based on the first motor coast down time 247. The motor velocity 252 can be calculated based on the first motor coast down time 247 using, for example, a suitable transfer function or other suitable mathematical relationship. For example, the present inventors have empirically developed relationships between first motor coast down time 247 and motor velocity 252, based for example on the relationship between first motor coast down time 247 and motor friction. In this manner, determination of the load mass as disclosed herein compensates for the motor friction.

Method 200 may further include, for example, the step 260 of finally activating the motor 94 to spin the basket 70. Further, method 200 may include the step 265 of deactivating the motor 94 after the motor velocity 252 has been reached. Still further, method 200 may include the step 270 of measuring a second motor coast down time 272. The coast down time 272 is generally the time that the motor 94 takes to reach zero velocity or a predetermined low velocity once the motor 94 has been deactivated.

Method 200 may further include, for example, the step 275 of calculating a load mass 277 in the basket 70 based on the second motor coast down time 272. The load mass 277 can be calculated based on the second motor coast down time 272 using, for example, a suitable transfer function or other suitable mathematical relationship. For example, the present inventors have empirically developed relationships between second motor coast down time 272 and load mass 277, based for example on the relationship between second motor coast down time 272 and moment of inertia.

Accordingly, the mass 277 of a load of articles loaded into a basket 70 can efficiently and accurately be determined through the use of a series of motor 94 activations. As discussed, operations of the washing machine appliance 50 can advantageously be tailored using this known mass 277, and the mass 277 can further be utilized for other purposes, such as to determine a load type as discussed herein.

Referring now to FIG. 4, a method 300 for operating a washing machine appliance 50 is disclosed. The methods 300 may include various steps for determining whether sufficient water has been provided in the tub 64 for optimal appliance 50 operation. If required, additional water can be added such that optimal operation is facilitated. Additionally, in some embodiments, method 300 may include various steps for determining a load type for the articles within the basket 70, such that further tailored operation of the appliance can be provided.

For example, method 300 may include the step 310 of flowing a first volume of water 312 into the tub 64. The first volume 312 is generally a main volume of water for performing a typical wash or rinse cycle. Method 300 may further include, for example, the step 315 of agitating the load in the basket 70, as discussed herein.

Further, method 300 may include, for example, the step 320 of monitoring a travel condition 322 of the motor 94 during the agitating step 315. The travel condition 322 may indicate whether the motor 94 is performing generally optimally. For example, in some embodiments, the travel condition 322 is time per rotation of the motor 94. Accordingly, the time that it takes for the motor 94 to complete a single full rotation or number of full rotations may be monitored. In alternative embodiments, the travel condition 322 is rotational distance per predetermined time period. Accordingly, the distance that the motor 94 travels (relative to a full rotation, for example) within a predetermined time period may be monitored. The travel condition 322 may then be compared to a predetermined threshold window 327 in step 325. The threshold window 327 may be a range of times or rotational amounts, for example. In embodiments wherein the travel condition 322 is time per rotation, the threshold window 327 may, for example, be any time less than or equal to a predetermined maximum satisfactory time for generally optimal motor 94 performance. In embodiments wherein the travel condition 322 is rotational distance per predetermined time period, the threshold window 327 may, for example, be any distance greater than or equal to a predetermined minimum satisfactory distance for generally optimal motor 94 performance.

Method 300 may further include, for example, the step 330 of flowing a predetermined secondary volume of water 332 into the tub 64. Such step 330 may occur, for example, if the travel condition 322 is outside of the predetermined threshold window 327. A travel condition 322 outside of the window 327 may generally indicate that the motor 94 is not operating optimally. Such non-optimal performance may be due to the first volume of water 312 being insufficient, and the articles in the load thus bogging down the motor 94. Accordingly, the predetermined secondary volume of water 332 may increase the overall volume of water in the tub 64, thus reducing any bogging down of the motor 94 and increasing motor 94 performance.

In some embodiments, the predetermined secondary volume of water 332 is generally equal under all conditions, such as for any disparity between the travel condition 322 and the window 327. In other embodiments, the secondary volume 332 may vary based on the disparity between the travel condition 322 and the window 327. For example, the predetermined secondary volume of water 332 may be based on a difference between the predetermined threshold window 327 and the travel condition 322. If the difference is large, indicating a relatively more significant bogging down of the motor 94 and/or need for additional water, the predetermined secondary volume of water 332 may be a relatively larger volume. If the difference is small, indicating a relatively less significant bogging down of the motor 94 and/or need for additional water, the predetermined secondary volume of water 332 may be a relatively smaller volume. Two, three, four or more varying volumes may be utilized, and may each correspond to a varying difference between the predetermined threshold window 327 and the travel condition 322.

In some embodiments, method 300 may further include the step 340 of determining if a maximum water volume 342 has been reached. The maximum water volume 342 may generally be a maximum volume level that water in the tub 64 is not permitted to exceed. Such step 340 may occur, for example, if the travel condition 322 is outside of the predetermined threshold window 327. Further, in exemplary embodiments, such step 340 may occur before the step 330 of flowing the predetermined secondary volume of water 332 into the tub 64. In these embodiments, the step 330 may then occur only if the travel condition 322 is outside of the predetermined threshold window 327 and if the maximum water volume 342 has not been reached. If the maximum water volume 342 has been reached, the step 330 may not occur. Accordingly, overfilling of the tub 64 may advantageously be prevented.

As discussed, method 300 may further include various steps for advantageously determining the load type for the articles in the basket 64. For example, method 300 may include the step 350 of determining the load mass 352 in the basket 64. In some exemplary embodiments, method 200 may be utilized to determine the load mass, and the load mass 277 may be utilized as the load mass 352 in the method 300. Alternatively, any suitable method and/or apparatus may be utilized to determine the load mass 352.

Method 300 may further include, as discussed, the step 310 of flowing the first volume of water 312 into the tub 64. In some exemplary embodiments, this step 310 may include the step 360 of flowing water into the tub 64 until a predetermined tub water pressure level 362 is met. The pressure level 362 may be determined by, for example, the pressure sensor 110. The step 310 may further, for example, include the step 365 of estimating the first volume of water 312 after the predetermined tub water pressure level 362 is met. The pressure level 362 and volume 312 can be correlated such that the volume 312 can be estimated. For example, in some embodiments, the estimating step 365 is further based on an assumed flow rate 367 of water into the tub 64. The assumed flow rate 367 is an assumed rate at which water will flow from, for example, main valve 74 to the tub 64. Suitable flow regulators may, in some embodiments, be utilized in the appliance 50 such that the actual flow rate can be adjusted to a rate approximating the assumed flow rate 367. The assumed flow rate 367 is thus known, as is the time 369 required for the pressure level 362 to be met. Based on these variables (pressure level 362 being met, resulting time 369 to meet such pressure level 362, and assumed flow rate 367), the first volume of water 312 can be estimated.

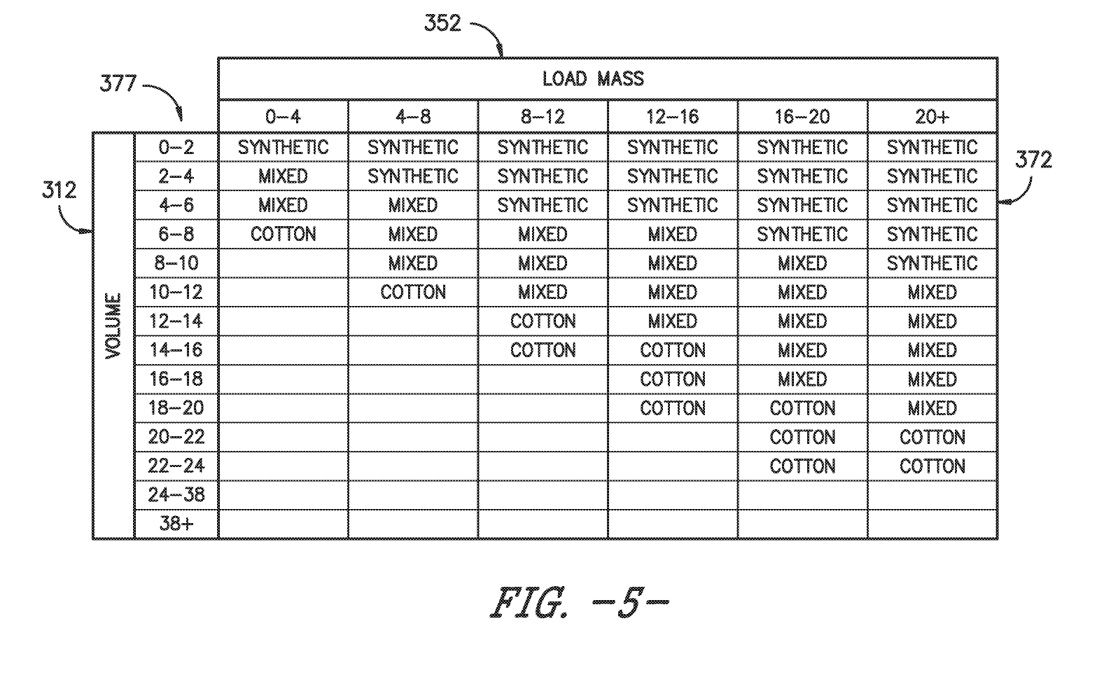

Further, the method 300 may include the step 370 of determining a load type 372. The load type 372 may be based on the load mass 352 and the first volume of water 312. For example, in exemplary embodiments, step 370 may include the step 375 of cross-referencing the load mass 352 and the first volume of water 312 in a look-up table 377. FIG. 5 illustrates one embodiment of a look-up table 377, with non-limiting examples of load mass 352 categories, first volume of water 312 categories, and resulting load types 372. (It should be noted that load mass 352 may be converted to weight for purposes of cross-referencing, or at any other point during utilization of a method in accordance with the present disclosure. The use of the term mass may thus be considered to include the term weight). Such categories may generally be based on the absorbency of various types of articles, such as synthetic articles and cotton articles. Since cotton tends to be more absorbent than synthetics, more water would be required for the same load size. Accordingly, a higher first volume of water 312 would be expected for a load mass 352 of cotton as opposed to the same load mass 352 of synthetics. It should be understood that the present disclosure is not limited to cotton, synthetic, and mixed (cotton and synthetic) categories, and rather that any suitable categories of load types 372, as well as any suitable load mass 352 categories and first volume of water 312 categories, are within the scope and spirit of the present disclosure. Look-up table 377 may generally be programmed into the controller 100, such that controller 100 can generally perform the steps as disclosed herein.

After determining the load type 372, a main wash or rinse may generally occur. Further, the various steps as discussed herein with respect to determining whether sufficient water has been provided in the tub 64 for optimal appliance 50 operation may then occur, such as during a main wash or rinse.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for determining a load mass in a washing machine appliance, the method comprising:
initially activating a motor to spin a basket of the washing machine appliance;
measuring at least one of current or voltage of the motor before or during the initially activating step;
calculating a motor ramp up time based on the at least one of current or voltage;
deactivating the motor after the motor ramp up time has expired;
measuring a first motor coast down time;
calculating a motor velocity based on the first motor coast down time;
finally activating the motor to spin the basket;
deactivating the motor after the motor velocity has been reached;
measuring a second motor coast down time; and
calculating a load mass in the basket based on the second motor coast down time.

2. The method of claim 1, further comprising deactivating the motor after measuring the at least one of current or voltage.

3. The method of claim 2, further comprising intermediately activating the motor to spin the basket.

4. The method of claim 1, wherein the at least one of current or voltage is current.

5. The method of claim 4, wherein measuring the current occurs during the initially activating step.

6. The method of claim 1, wherein the at least one of current or voltage is voltage.

7. The method of claim 6, wherein measuring the voltage occurs before the initially activating step.

8. The method of claim 6, wherein measuring the voltage occurs during the initially activating step.

9. A method for operating a washing machine appliance, the method comprising:
determining a load mass in a basket of the washing machine appliance;
flowing a first volume of water into a tub of the washing machine appliance, the basket disposed in the tub;
determining a load type based on the load mass and the first volume of water;
agitating the load;
monitoring a travel condition of a motor during the agitating step;
comparing the travel condition to a predetermined threshold window; and
flowing a predetermined secondary volume of water into the tub if the travel condition is outside of the predetermined threshold window.

10. The method of claim 9, wherein the flowing step comprises flowing water into the tub until a predetermined tub water pressure level is met.

11. The method of claim 10, wherein the flowing step further comprises estimating the first volume of water after the predetermined tub water pressure level is met.

12. The method of claim 11, wherein estimating the first volume of water is further based on an assumed flow rate of water into the tub.

13. The method of claim 9, wherein determining the load type comprises cross-referencing the load mass and the first volume of water in a look-up table.

14. The method of claim 9, further comprising determining if a maximum water volume has been reached if the travel condition is outside of the predetermined threshold window.

15. The method of claim 14, wherein flowing the predetermined secondary volume of water into the tub occurs if the travel condition is outside of the predetermined threshold window and if the maximum water volume has not been reached.

16. The method of claim 9, wherein the predetermined secondary volume of water is based on a difference between the predetermined threshold window and the travel condition.

17. The method of claim 16, wherein the travel condition is time per rotation.

18. The method of claim 16, wherein the travel condition is rotational distance per predetermined time period.
